(19) United States
(12) Patent Application Publication
(10) Pub. No.: US 2009/0000099 A1
(43) Pub. Date: Jan. 1, 2009

(54) Fast-disassembling device for anti-reversing plates of a cutting base of a table saw

(76) Inventor: Bor-Yann Chuang, Taichung (TW)

Correspondence Address: BACON & THOMAS, PLLC, 625 SLATERS LANE, FOURTH FLOOR, ALEXANDRIA, VA, 22314-1176, US

(21) Appl. No.: 11/819,357

(22) Filed: Jun. 27, 2007

(51) Int. Cl. B23P 19/00

(52) U.S. Cl. 29/283

(57) ABSTRACT

A fast-disassembling device for anti-reversing plates of a cutting base of a table saw includes an assembling base to be installed on a separating plate, which has a pivotal recess cut at the top of its one side and a locking groove with an opening located next the pivotal recess. The assembling base has a restricting shaft fitted in the pivotal recess to form as a rotation pivot, able to keep a blocking shaft facing against the locking groove. The blocking shaft at least includes a releasing portion and a blocking portion. The releasing portion can be moved to pass through the opening to enter the locking groove while pressing the blocking shaft to move axially. And, the blocking portion is moved in the locking groove restricted by the opening while releasing the blocking shaft to move back to its original position automatically.

### BACKGROUND OF THE INVENTION

1. Field of the Invention

This invention relates to a table saw, particularly to one having a fast-disassembling device able to keep two anti-reversing plates of a cutting base of the table saw assembled with or disassembled from a separating plate quickly.

2. Description of the Prior Art

As shown in FIGS. 1 and 2, a conventional cutting base 10 is composed of a separating plate 11, two anti-reversing plates 12 and a fast-disassembling device 13. The fast-disassembling device 13 is provided with an assembling base 131, two male nuts 132, an elastic element 133, a blocking pin 134, a positioning pivot 135, a compression spring 136 and a knob 137. The assembling base 131 is provided with a plugging slot 1311 for engaging with a connecting portion 111 of the separating plate 11, keeping its outer surface resting on a positioning edge 112 of the separating plate 11 so as to enable the positioning pivot 135 to be fitted in a pivotal opening 113 of the separating plate 11. The knob 137 can push the positioning pivot 135 to make a displacement while pressed, so that the positioning pivot 135 can be moved away from the pivotal opening 113 to keep the assembling base 131 and the anti-reversing plates 12 separated from the separating plate 11. However, the conventional fast-disassembling device 13 has so many components that it is complicated to assemble and disassemble it, posing a raise for cost. Moreover, it is not easy to smoothly enable the positioning pivot 135 to fit in or separated from the pivotal opening 113 unless the relative displacement between the positioning pivot 135 and the knob 137 is controlled to precisely correspond to the edge center of the connecting portion 111 of the separating plate 11. That is, the operating reliability needs to be improved.

### SUMMARY OF THE INVENTION

The objective of this invention is to offer a fast-disassembling device for anti-reversing plates of a cutting base of a table saw.

The fast-disassembling device includes an assembling base to be assembled with or disassembled from a separating plate. The assembling base has a restricting shaft for being fitted in a pivotal recess of the separating plate to form as a rotation pivot, able to keep a blocking shaft facing against a locking groove. The blocking shaft includes at least a releasing portion and a blocking portion. The releasing portion can be moved to pass through an upper opening to enter the locking groove while pressing the blocking shaft to move axially. And, the blocking portion is to be moved in the locking groove to be restricted by the upper opening while releasing the blocking shaft to let it move back to its original position automatically. The components of the fast-disassembling device are so simple that they can be assembled easily. In assembling, a user can rapidly put the restricting shaft positioned in the pivotal recess and keep the blocking shaft restricted in or separated from the locking groove of the separating plate, So, it is really easy to swiftly assemble and disassemble the anti-reversing plates.

### BRIEF DESCRIPTION OF DRAWINGS

This invention is better understood by referring to the accompanying drawings, wherein:

FIG. 1 is an exploded view of conventional anti-reversing plates for a cutting base of a table saw;

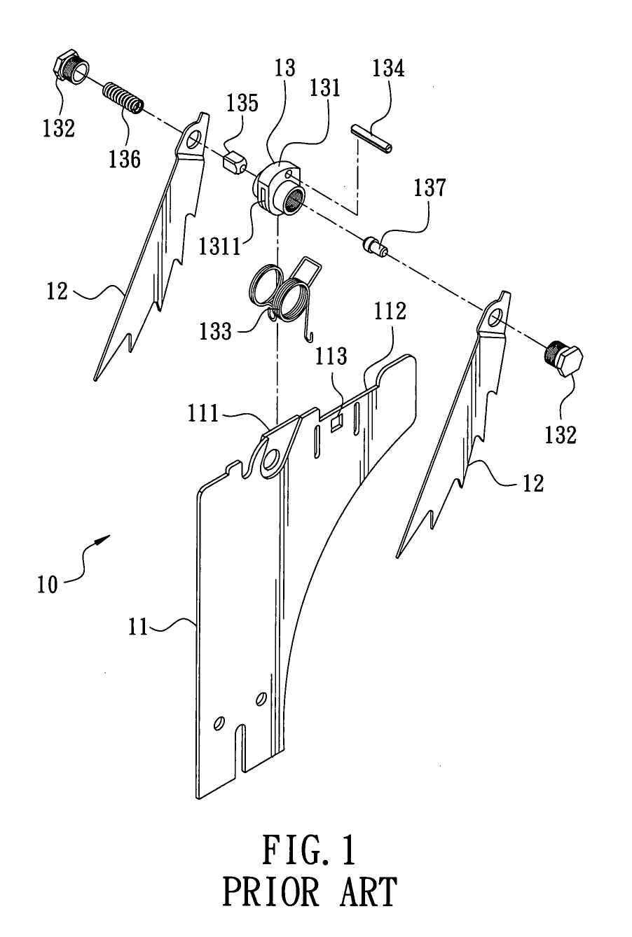

FIG. 2 is a cross-sectional view of the conventional anti-reversing plates for a cutting base of a table saw;

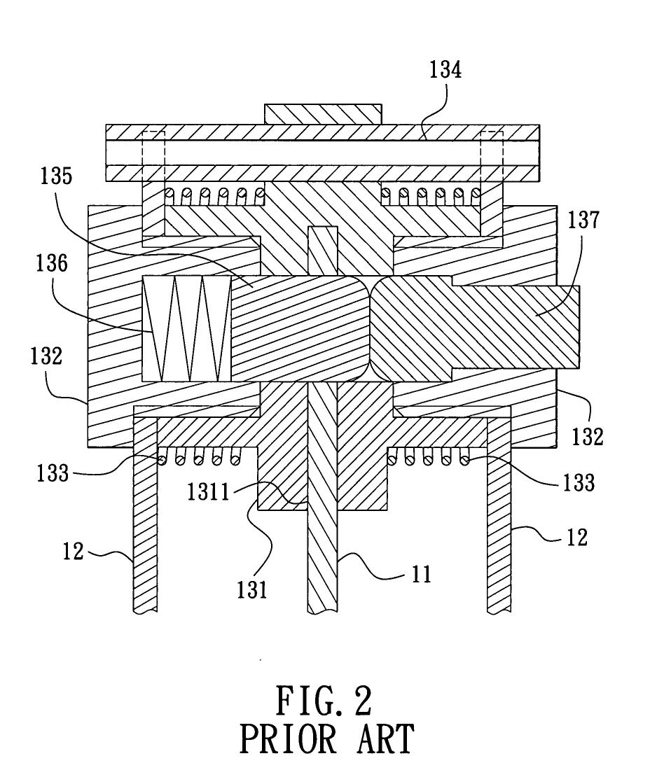

FIG. 3 is a perspective view of a preferred embodiment of a fast-disassembling device for anti-reversing plates of a cutting base of a table saw;

FIG. 4 is a partial exploded perspective view of the preferred embodiment of a fast-disassembling device for anti-reversing plates of a cutting base of a table saw;

FIG. 5 is a side view of the preferred embodiment of a fast-disassembling device for anti-reversing plates of a cutting base of a table saw;

FIG. 6 is a side view of the preferred embodiment of a fast-disassembling device for anti-reversing plates of a cutting base of a table saw, showing it being operated; and

FIG. 7 is cross-sectional view of the preferred embodiment of a fast-disassembling device for anti-reversing plates of a cutting base of a table saw, showing it being operated.

### DETAILED DESCRIPTION OF THE PREFERRED EMBODIMENT

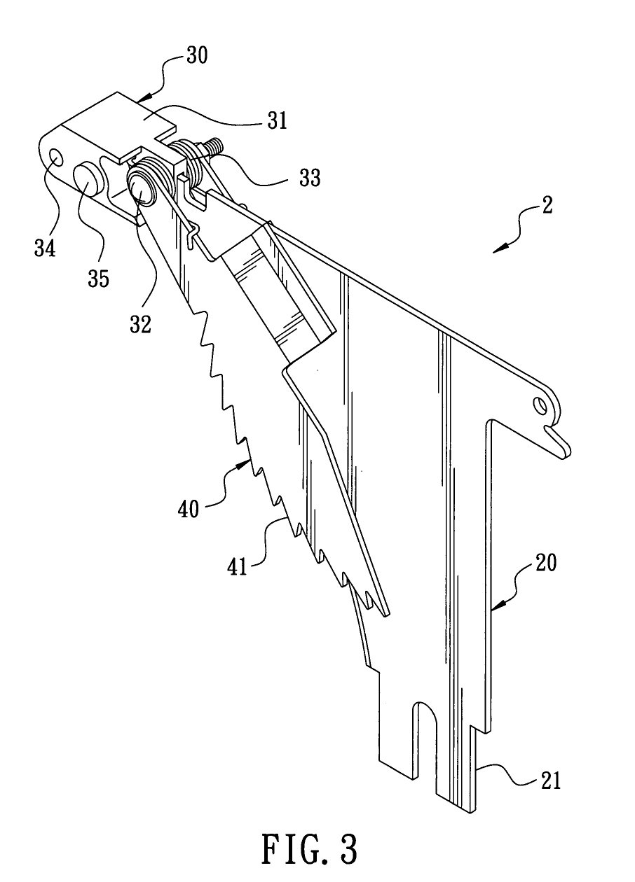

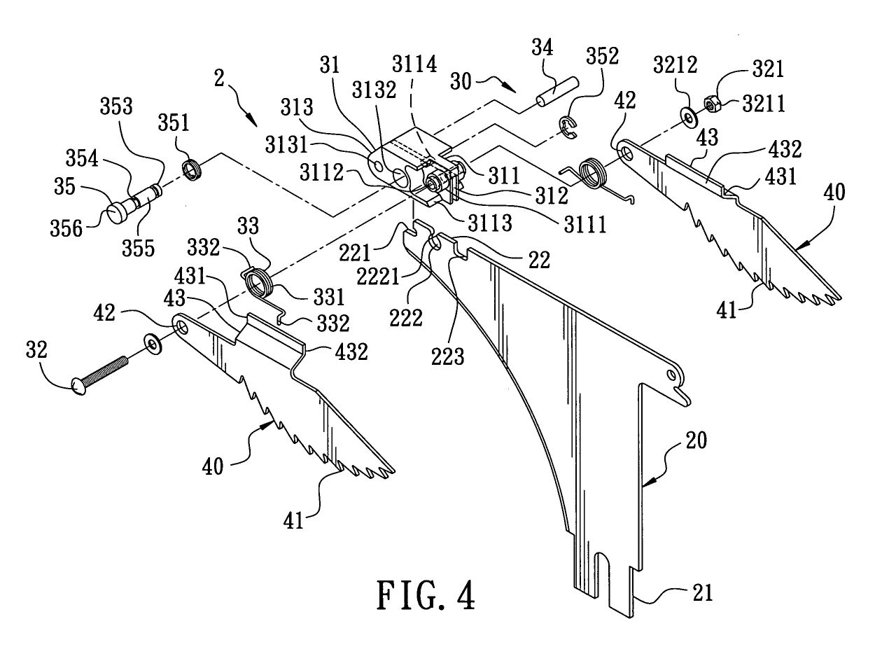

FIGS. 3 and 4 show a preferred embodiment of a fast-disassembling device for anti-reversing plates of a cutting base of a table saw in the present invention. The cutting base 2 is composed of a separating plate 20, a fast-disassembling device 30 and two anti-reversing plates 40.

The separating plate 20 is provided with a fixing portion 21 located at its lower portion for being positioned on the table saw (not shown in Figures), and a connecting portion 22 formed at its top portion. The connecting portion 22 is provided with a pivotal recess 221 cut at the top of its one side, and a locking groove 222 bored next the pivotal recess 221, having an upper opening 2221 formed at its top. The connecting portion 22 is also provided with a storing groove 223 formed U-shaped and located next and in parallel with the locking groove 222.

The fast-disassembling device 30 is composed of an assembling base 31, a pivotal shaft 32, two torsion springs 33, a restricting shaft 34 and a blocking shaft 35.

The assembling base 31 includes a pivotal connecting portion 311 formed at its one side. The connecting portion 311 is provided with a tube 3111 extended out to two opposite directions from its central portion respectively, a pivotal hole 3112 bored through the center of the tubes 3111, a restricting block 3113 formed as a rectangular bar and axially extended from two sides of its bottom respectively, and a hook hole 3114 set interiorly. In addition, the assembling base 31 is provided with a plugging slot 312 dug longitudinally through its center for fitting with the connecting portion 22 of the separating plate 20, and an assembling-disassembling portion 313. The assembling-disassembling portion 313 is provided with a rotating hole 3131 and a locking hole 3132, which are respectively set to correspond to the pivotal recess 221 and the locking groove 222, positioned vertically to the plugging slot 312.

The pivotal shaft 32 is inserted in the pivotal hole 3112, provided with a dead-screwing member 321 fixed outside the other tube 3111. The dead-screwing member 321 is composed of a nut 3211 and a washer 3212.

Each of the torsion spring 33 is provided with an annular ring group 331 formed at its center for mounting around the tube 3111 of the assembling base 31, and a hook 332 extended outward axially from its two sides respectively.

The restricting shaft 34 is inserted in the rotating hole 3131 and through the plugging slot 312 with a portion exposed there out.

The blocking shaft 35 is inserted in the locking hole 3132, provided with a compression spring 351 that is also inserted in the locking hole 3132, restricted around a locking portion 353 by a C-shaped locking element 352. The blocking shaft 35 is also provided with a releasing portion 354 located slightly leftward to its intermediate portion with a smaller diameter, a blocking portion 355 located next the releasing portion 354 with a larger diameter, and a knob 356 formed at its end. The knob 356 is positioned outside the assembling base 31 so as to enable the blocking shaft 35 axially moved to keep the releasing portion 354 pushed to correspond to the plugging slot 312 while being pressed.

Each of the anti-reversing plates 40 is provided with a toothed portion 41 located at its lower edge, and a pivotal shaft hole 42 bored at its upper end to correspond to the tube 3111, for the pivotal shaft 32 to pass through it and also the pivotal hole 3112 so as to keep the anti-reversing plates 40 pivotally fixed on the assembling base 31, positioned axially at two sides of the separating plate 20. By the time, the restricting block 3113 can just restrictively support and keep the anti-reversing plates 40 pivotally positioned at two sides of the assembling base 31 obliquely. In addition, the anti-reversing plates 40 are respectively provided with a leaning plate 43 extended horizontally from the intermediate portion of its upper edge. The leaning plate 43 is provided with a bent portion 431 formed by vertically bending its rear portion and having a leaning surface 432. By means of the leaning plate 43, each of the anti-reversing plates 40 is properly spaced apart from the separating plate 20. And, one of the hooks 332 is locked on an edge of the adjacent side of the leaning plate 43 of the anti-reversing plates 40, and the other hook 332 is hooked in the hook hole 3114, so that the anti-reversing plates 40 can be elastically supported by the hooks 332 of the torsion spring 33.

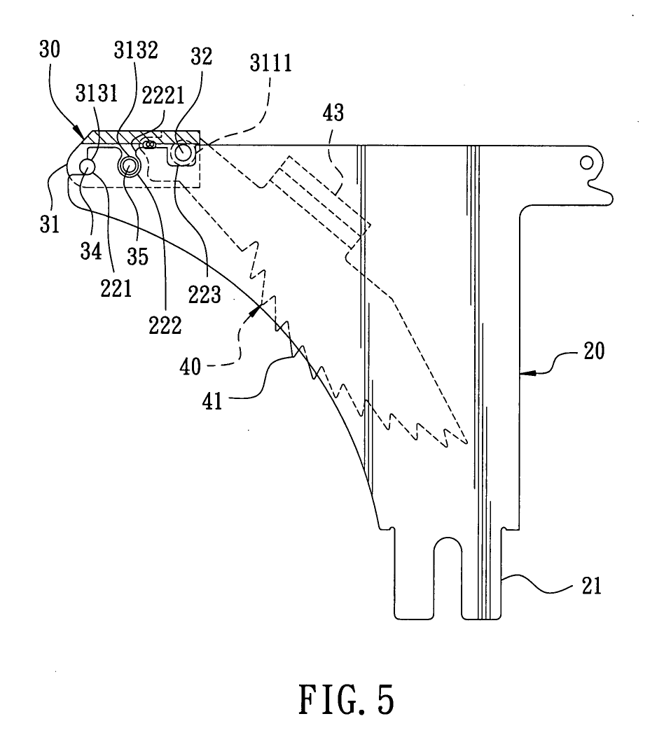

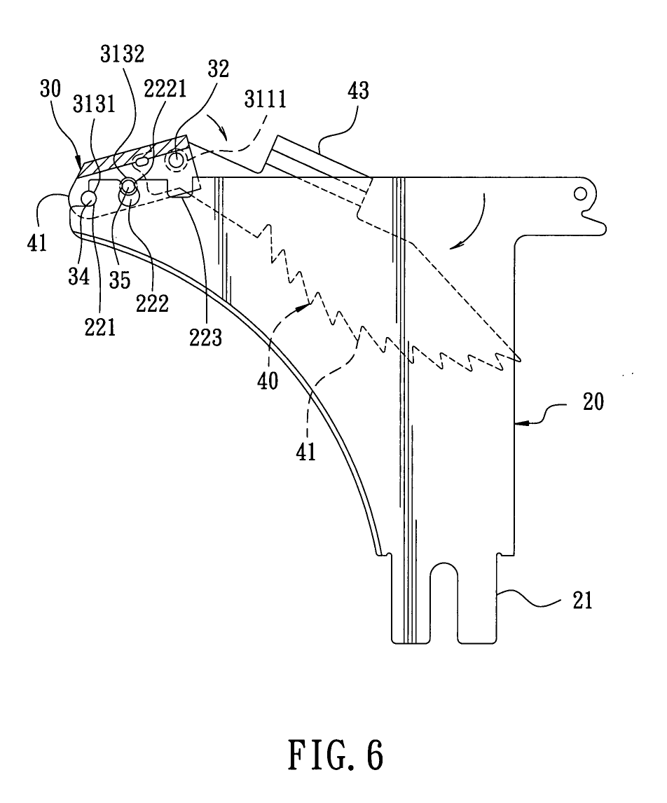

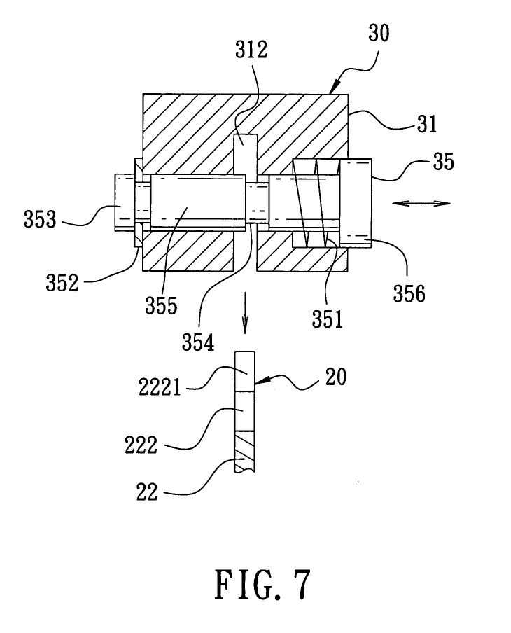

As shown in FIGS. 5-7, when the anti-reversing plates 40 are to be assembled with the separating plate 20, the portion of the restricting shaft 34 exposed out of the plugging slot 312 is first engaged with the pivotal recess 221 to form as a rotation pivot. By the time, the blocking shaft 35 is lying on the top of the locking groove 222. Next, the knob 356 is pressed to keep the blocking shaft 35 moved axially to enable the releasing portion 354 positioned to face against the plugging slot 312 and the locking groove 222 and then, press down the assembling base 31 to squeeze the releasing portion 354 into the locking groove 222 from the opening 2221. The knob 354 is then released so that the blocking shaft 35 can be elastically pushed back to its original position by the torsion spring 351. By the time, the blocking portion 355 is automatically moved into the locking groove 222, restricted by the opening 2221; the pivotal shaft 32 is supported by the storing groove 223. Therefore, as the anti-reversing plates 40 are elastically pressed down, the toothed portion 41 can lean on the surface of a workpiece while sawing, so as to keep the workpiece running in a steady direction.

On the contrary, if the anti-reversing plates 40 are to be separated from the separating plate 20, it is necessary to press the knob 356 to move the releasing portion 354 of the blocking shaft to face against the plugging groove 312 and the locking groove 222. Next, the assembling base 31 can be rotated by pivoting the restricting shaft 34, so that the releasing portion 354 can pass through the opening 2221 to move away from the locking groove 222. Then, the restricting shaft 34 can be moved outward to be separated from the pivotal recess 221. So, the anti-reversing plates 40 are quickly disassembled from the separating plate 20.

The advantages of the invention are described below as can be seen from the foresaid description.

The components of the fast-disassembling device 30 are so simple that they are able to be assembled easily. In assembling, a user has only to place the restricting shaft 34 to rapidly rest on the pivotal recess 221 and then, press the knob 356 to keep the blocking shaft 35 restricted in the locking groove 222. And then, the blocking shaft 35 can be released from the locking groove 222 and the restricting shaft 34 can be quickly moved off the pivotal recess 221 if operated by a reverse procedure. It is therefore easy to swiftly assemble and disassemble the anti-reversing plates 40.

While the preferred embodiment of the invention has been described above, it will be recognized and understood that various modifications may be made therein and the appended claims are intended to cover all such modifications that may fall within the spirit and scope of the invention.

What is claimed is:

1. A fast-disassembling device for anti-reversing plates of a cutting base of a table saw comprising:
a separating plate provided with a pivotal recess formed at one side of its top, and a locking groove located next said pivotal recess with a gap;
said fast-disassembling device including an assembling base that can be assembled on a top portion of said separating plate, provided with a restricting shaft and a blocking shaft, said restricting shaft fitted in said pivotal recess of said separating plate to form as a rotation pivot so that said blocking shaft can be moved to rest on a top of said locking groove, said blocking shaft at least having a releasing portion with a smaller diameter and a blocking portion with a larger diameter, said releasing portion able to relatively enter said locking groove through said opening while pressing said blocking shaft to move axially, said blocking shaft to be elastically pushed back to its original position while released, then said blocking portion restricted in said locking groove; and
two anti-reversing plates installed pivotally with said assembling base and correspondingly located at two sides of said separating plate.

2. The fast-disassembling device for anti-reversing plates of a cutting base of a table saw as claimed in claim 1, wherein said assembling base of said fast-disassembling device is provided with a plugging slot dug longitudinally through its center for fitting with said separating plate, a rotation hole bored vertically through said plugging groove, and a locking hole bored at a location corresponding to said locking groove and parallel with said rotation hole, said restricting shaft inserted in said rotation hole for said assembling base to engage with said pivotal recess of said separating plate, said releasing portion able to be pushed to face against said plugging slot and said locking groove while said blocking shaft is pressed to move axially so that it can enter said locking groove by passing through said opening, said blocking shaft able to move back to its original position if released, keeping said blocking portion positioned in said locking groove and restricted by said opening.

3. The fast-disassembling device for anti-reversing plates of a cutting base of a table saw as claimed in claim 2, wherein said blocking shaft is mounted with a compression spring that is inserted in said locking hole and restricted by a locking element located at another end of said blocking shaft, said blocking shaft also provided with a knob able to be extended out of said assembling base by the elasticity of said compression spring.

4. The fast-disassembling device for anti-reversing plates of a cutting base of a table saw as claimed in claim 1, wherein each of said anti-reversing plates is provided with a toothed portion located at its lower edge and a pivotal shaft hole bored at one end of its upper edge, and said assembling base is provided with a pivotal connecting portion corresponding to said anti-reversing plates, said pivotal connecting portion provided with a tube respectively extended outward from its two sides in corresponding to said pivotal shaft hole, said tubes having a pivotal hole bored through their center for a pivotal shaft to pass through it and said pivotal shaft hole, said pivotal shaft fixed outside another tube by a dead-screwing member so as to enable said anti-reversing plates pivotally assembled with said pivotal connecting portion, said separating plate provided with a storing groove that is cut at a location corresponding to said pivotal shaft and aligned with said locking groove, for supporting said pivotal shaft while installing said assembling base on said separating plate.

5. The fast disassembling device for anti-reversing plates of a cutting base of a table saw as claimed in claim 4, wherein said pivotal connecting portion of said assembling base is provided with a restricting block formed as a rectangular bar and axially extended from two sides of its bottom respectively for keeping said anti-reversing plates pivotally positioned at two sides of said assembling base obliquely while assembling said anti-reversing plates therewith.

6. The fast-disassembling device for anti-reversing plates of a cutting base of a table saw as claimed in claim 4, wherein said pivotal connecting portion of said assembling base is provided with a hook hole set interiorly and a torsion spring installed around each of said tubes, said torsion spring having an annular ring group formed at its central portion for mounting around said tube, and a hook extended outward from its two ends respectively for locking with said hook hole and one side of said anti-reversing plates so as to keep said anti-reversing plates elastically pressed down by said torsion spring, thus enabling said toothed portion to press on a surface of a workpiece to keep said workpiece moving forward in a steady direction.

7. The fast-disassembling device for anti-reversing plates of a cutting base of a table saw as claimed in claim 4, wherein said anti-reversing plates are respectively provided with a leaning plate extended from an intermediate portion of its upper edge, said leaning plate including a bent portion formed by obliquely bending its end portion to obtain a leaning portion to keep said anti-reversing plates spaced apart while assembling said anti-reversing plates at two sides of said separating plate.
